(19) United States
(12) Patent Application Publication
(10) Pub. No.: US 2026/0307726 A1
(43) Pub. Date: Oct. 8, 2026

(54) SIDE STRUCTURE OF VEHICLE BODY

(71) Applicants: Hyundai Motor Company, Seoul (KR); Kia Corporation, Seoul (KR)

(72) Inventors: Hae Hoon Lee, Hwaseong-si (KR); Yun Bae Chun, Hwaseong-si (KR); Sang Yeob Lee, Hwaseong-si (KR); Hoje Kang, Hwaseong-si (KR); Dong Wook Kim, Hwaseong-si (KR); Hoyeon Kim, Hwaseong-si (KR)

(21) Appl. No.: 19/396,044

(22) Filed: Nov. 20, 2025

(30) Foreign Application Priority Data
Apr. 2, 2025 (KR) 10-2025-0042551
Jul. 24, 2025 (KR) 10-2025-0100175

(51) Int. Cl. B62D 25/02; B62D 25/04; B62D 25/06; B62D 65/02

(52) U.S. Cl. CPC B62D 25/02; B62D 25/04; B62D 25/06; B62D 65/02

(57) ABSTRACT

The present disclosure relates to a side structure for a vehicle body. The side structure may include a main side body that includes a rear quarter assembly at a rear portion of the main side body, a variable part optionally connectable to a rear portion of the rear quarter assembly, and a common part connectable to the rear portion of the rear quarter assembly according to a first configuration and a rear portion of the variable part according to a second configuration.

### CROSS-REFERENCE TO RELATED APPLICATIONS

This application claims priority to and the benefit of Korean Patent Application No. 10-2025-0042551, filed with the Korean Intellectual Property Office on Apr. 2, 2025, and Korean Patent Application No. 10-2025-0100175, filed with the Korean Intellectual Property Office on Jul. 24, 2025, the entire contents of which are incorporated herein by reference.

### TECHNICAL FIELD

The present disclosure relates to a vehicle body.

### BACKGROUND

Recently, the vehicle industry has been introducing a new concept of future mobility vision for realizing a human-centered and dynamic future city. One of these future mobility solutions is a purpose-built vehicle (PBV) as purpose-based mobility.

The PBV is an example of an eco-friendly mobility vehicle based on an electric vehicle (EV). Such a PBV may provide a user with a variety of customized services during travel from a departure point to a destination.

The PBV may be manufactured in various shapes and sizes depending on a use case of a user. For example, the PBV may be used as a hailing or delivery type vehicle.

Such a PBV is equipped with side structures of various specifications, each having a different rear overhang depending on an intended purpose and specific use cases.

For example, the PBV may have a side structure of a basic body type having a set rear overhang and may have a side structure of a long body type having a rear overhang greater than a rear overhang of a basic body type side structure.

Side structures of the basic body type and the long body type are custom designed from the initial design stage, so a development period and tooling investment costs for manufacturing diversified components of the side structures may increase depending on specifications.

The above information disclosed in this Background section is only for enhancement of understanding of the background of the present disclosure, and therefore, it may contain information that does not form the prior art that is already publicly known, available, or in use.

### SUMMARY

The present disclosure relates to a vehicle body, and more particularly to a side structure for a vehicle body and to production of various vehicle bodies.

Embodiments of the present disclosure provide a body side structure capable of being easily modified to a long body type side structure while maximizing commonality of a side structure of a basic body type.

A body side structure, according to an example embodiment, may include: i) a main side body including a rear quarter assembly provided at a rear portion; ii) a variable module selectively joined to a rear portion of the rear quarter assembly; and iii) a common module selectively joined to a rear portion of the rear quarter assembly or a rear portion of the variable module.

Additionally, in the body side structure, according to the example embodiment, the variable module may be a rear quarter extension member.

Additionally, in the body side structure, according to the example embodiment, the common module may be a rear pillar member.

Additionally, in the body side structure, according to the example embodiment, the variable module may be joined to the rear portion of the rear quarter assembly along the width direction in a matching joining manner.

In addition, in the body side structure, according to the example embodiment, the common module may be joined to the rear portion of the variable module along the width direction in a matching joining manner.

In addition, in the body side structure, according to the example embodiment, the rear quarter assembly may include a main joining portion formed in a vertical direction at the rear portion.

In addition, in the body side structure, according to the example embodiment, the common module may include a rear pillar member.

In addition, in the body side structure, according to the example embodiment, the rear pillar member may include a common joining portion formed in a vertical direction in a front portion.

In addition, in the body side structure, according to the example embodiment, the main joining portion and the common joining portion may be joined to each other along a vehicle width direction by matching sections having a same shape, in which matching surfaces are formed.

In addition, in the body side structure, according to the example embodiment, the variable module may include a rear quarter extension member.

In addition, in the body side structure, according to the example embodiment, the rear quarter extension member may include a front variable joining portion formed along the vertical direction in a front portion to be joined with the main joining portion, and a rear variable joining portion formed in the vertical direction at a rear portion to be joined with the common joining portion.

In addition, in the body side structure, according to the example embodiment, the main joining portion and the front variable joining portion may be joined to each other along a vehicle width direction by matching sections having a same shape, in which matching surfaces are formed.

In addition, in the body side structure, according to the example embodiment, the common joining portion and the rear variable joining portion may be joined to each other along a vehicle width direction by matching sections having a same shape, in which matching surfaces are formed.

In addition, in the body side structure, according to the example embodiment, each of the main joining portion, the common joining portion, the front variable joining portion, and the rear variable joining portion may include matching sections having a concavo-convex shape, in which matching protrusions and matching grooves are alternately formed along a vertical direction.

In addition, the body side structure, according to the example embodiment, may further include an optional module selectively joined to an upper portion of the common module.

In addition, in the body side structure, according to the example embodiment, the optional module may include a rear pillar extension member connected to a roof structure of different specifications.

In addition, in the body side structure, according to the example embodiment, the main side body and the common module, which are joined to each other, may be provided as a basic side structure of a basic vehicle body.

In addition, in the body side structure, according to the example embodiment, the main side body, the variable module, and the common module, which are joined with each other, may be provided as a variable side structure of a variable body.

The body side structure, according to the example embodiment, may enable securing long-body performance of the variable vehicle body with an increased rear overhang, while reducing a development period, design workload, tooling investment cost, and manufacturing cost required for producing multiple vehicle body specifications.

Further, effects that can be obtained or expected from the disclosed example embodiments of the present disclosure are directly or suggestively described in the following detailed description. That is, various effects expected from the disclosed example embodiments will be described in the following detailed description.

### BRIEF DESCRIPTION OF THE DRAWINGS

These drawings are for reference in describing the disclosed embodiments, so the technical ideas of the disclosed embodiments should not be interpreted as being limited to the attached drawings.

FIG. 1 illustrates a side view showing a vehicle body of a PBV according to an embodiment of the present disclosure.

FIG. 2 illustrates a side view showing a body side structure according to an embodiment of the present disclosure.

FIG. 3 illustrates a perspective view showing an example of a body side structure according to an embodiment of the present disclosure.

FIG. 4 illustrates an exploded perspective view showing an example of a body side structure according to an embodiment of the present disclosure.

FIG. 5 illustrates a cross-sectional view showing a joining structure between a main side body and a common module, as applied to an example of a body side structure according to an embodiment of the present disclosure.

FIG. 6 illustrates a perspective view showing another example of a body side structure according to an embodiment of the present disclosure.

FIG. 7 illustrates an exploded perspective view showing another example of a body side structure according to an embodiment of the present disclosure.

FIG. 8 illustrates a cross-sectional view showing a joining structure between a main side body and a variable module, as applied to another example of a body side structure according to an embodiment of the present disclosure.

FIG. 9 illustrates a cross-sectional view showing a joining structure between a variable module and a common module, as applied to another example of a body side structure according to an embodiment of the present disclosure.

FIG. 10 illustrates a side view illustrating one example and another example of a body side structure according to an embodiment of the present disclosure.

It should be understood that the drawings referenced above are not necessarily drawn to scale, but rather present simplified representations of various features that illustrate the basic principles of the example embodiments. For example, certain design features of the example embodiments, including specific dimensions, orientations, positions, and shapes, will be determined in part by the particular intended application and usage environment.

### DETAILED DESCRIPTION OF ILLUSTRATIVE EMBODIMENTS

Hereinafter, with reference to the accompanying drawings, the example embodiment will be described in detail such that a person having ordinary skill in the art to which the embodiment pertains can readily implement it. It should be understood that the example embodiment may be implemented in various modifications and variations and is not intended to be limited to the specific embodiment described herein.

The terminologies used herein are for the purpose of describing particular example embodiments, and are not intended to limit the present disclosure. As used herein, singular forms are intended to include plural forms as well, unless explicitly stated otherwise in the context.

It should also be understood that the terms “comprises” and/or “comprising” as used herein indicate the presence of stated features, integers, steps, operations, elements and/or components, but do not preclude the presence or addition of one or more other features, integers, steps, operations, components, and/or groups thereof. As used in this specification, the term “and/or” includes any and all combinations of one or more of the associated listed items.

As used in this specification, the term ”joined” refers to a physical relationship between two components that are either directly connected to each other by welding, self-piercing rivets (SPR), flow drill screws (FDS), structural adhesives, or the like, or indirectly connected through one or more intermediary components. Components that may be connected to other components may be referred to as “connectable” or “couplable.”

As used herein, the terms “vehicle,” “automobile,” “automotive,” or other similar expressions refer generally to passenger automobiles, including sedans, sports cars, sport utility vehicles (SUVs), buses, trucks, and various commercial vehicles, and may also encompass hybrid vehicles, electric vehicles, hybrid electric vehicles, electric-based Purpose Built Vehicles (PBVs), hydrogen-powered vehicles, and other alternative fuel vehicles (e.g., vehicles powered by fuels derived from resources other than petroleum).

Hereinafter, disclosed embodiments will be described in detail with reference to the attached drawings.

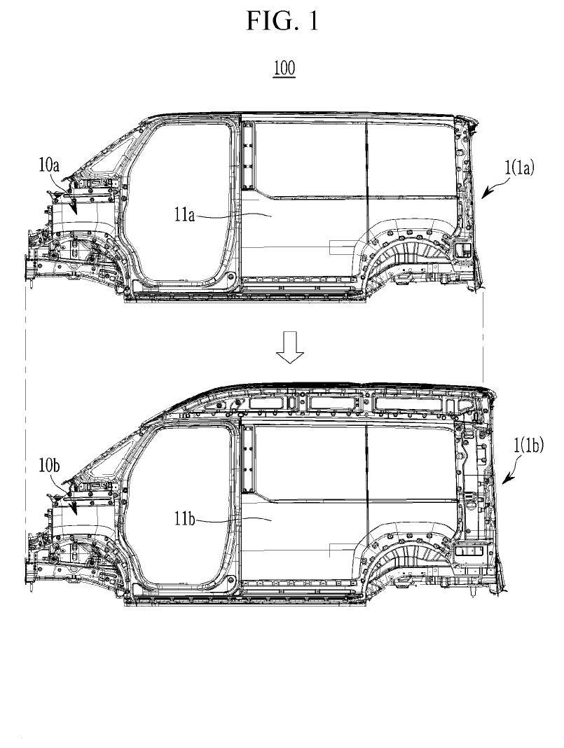

FIG. 1 illustrates a side view showing a vehicle body of a PBV to which a body side structure is applied according to an embodiment.

Referring to FIG. 1, the body side structure 100, according to the embodiment, may be applied to, e.g., a vehicle body 1 of a purpose-built vehicle (hereinafter referred to as 'PBV').

The PBV may serve as an electric vehicle-based life module that provides various customized services to a user during the time spent traveling from a departure point to a destination.

In one example, the PBV may be manufactured in a one box type design with a wide interior space. In another example, the PBV may include multiple rows of seats in the interior space, facing-type seats, or cushion tip up and down seats.

The vehicle body 1 of the PBV may be manufactured in various shapes and sizes depending on the intended purpose and specific use cases of the PBV.

Furthermore, the vehicle body 1 of the PBV can be used as various types of vehicles. For example, a hailing vehicle as a means of transporting passengers, a delivery vehicle for transporting goods, and a special vehicle such as an ambulance.

In the present disclosure, a reference direction for describing components below may be set as a front-rear direction of the vehicle body (e.g., body length direction or longitudinal direction), a width direction (e.g., lateral direction or left-right direction), and an up-down direction (e.g., height direction) based on the vehicle body.

In the present disclosure, the terms “upper end portion,” “upper portion,” “upper end” or “upper surface” of a component may indicate an end, section, segment, or surface of a component that is positioned relatively above in the drawings, whereas the terms “lower end portion,” “lower portion,” “lower end” or “lower surface” of a component may indicate an end, section, segment, or surface of a component that is positioned relatively below in the drawings

In the present disclosure, the term “end” of a component (e.g., a first end, a second end, or opposite ends) may refer to the terminal point of the component in a given direction, whereas the term “end portion” of a component (e.g., a first end portion, a second end portion, opposite end portions, a front end portion, or a rear end portion) may refer to a portion of a component that includes an end point.

Meanwhile, the vehicle body 1 of the PBV, as described above, may be a basic vehicle body 1a or a variable vehicle body 1b in an embodiment.

Herein, the basic vehicle body 1a and the variable vehicle body 1b, as described in the embodiments, may be vehicle bodies having different rear overhangs depending on the intended purpose and specific use cases of the PBV.

The basic vehicle body 1a may be defined as a body manufactured according to predetermined specifications, for example, a short body type configured with a flat roof structure rather than a high roof structure.

The variable vehicle body 1b may be defined as a vehicle body manufactured with specifications different from those of the basic vehicle body 1a, and may, for example, have a larger rear overhang than that of the basic vehicle body 1a and be configured as a long body type incorporating a high roof structure.

The body side structure 100, according to an embodiment, applicable to the vehicle body 1 of such a PBV, may include side structures 10a and 10b positioned on opposite lateral sides of the basic vehicle body 1a and the variable vehicle body 1b, respectively, in accordance with a vehicle width direction.

Hereinafter, the side structure 10a provided in the basic vehicle body 1a is referred to as the basic side structure 10a, and the side structure 10b provided in the variable vehicle body 1b is referred to as the variable side structure 10b.

Herein, as described above, each of the basic side structure 10a and the variable side structure 10b may include a basic side outer panel 11a and a variable side outer panel 11b.

The body side structure 100, according to an embodiment, may provide a structure capable of being easily changed to the variable side structure 10b of the variable vehicle body 1b while maximizing commonality of the basic side structure 10a of the basic vehicle body 1a.

That is, if the basic side structure 10a of the basic vehicle body 1a is made into a common configuration and the basic side structure 10a is easily changed to the variable side structure 10b of the variable vehicle body 1b, vehicle usability may be increased while reducing costs.

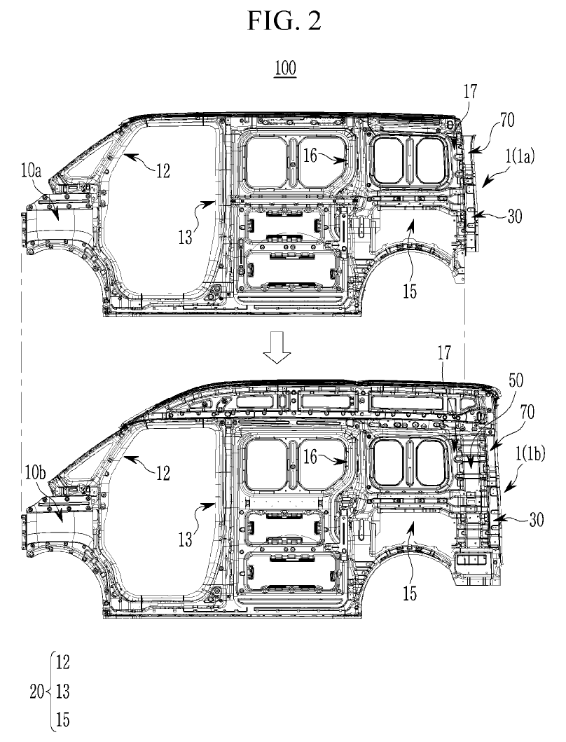

FIG. 2 illustrates a side view showing a body side structure according to an embodiment.

Referring to FIG. 2, the body side structure 100, according to embodiment, may include a main side body 20 provided on the basic side structure body 10a.

Furthermore, the body side structure 100, according to an embodiment, may include a common module 30, a variable module 50, and an option module 70. In various embodiments, the common module 30 may be referred to as a common part 30, the variable module 50 may be referred to as a variable part 50, and the optional module 70 may be referred to as an optional part 70.

In an embodiment, the main side body 20 may be defined as a fundamental body component that is not replaced even when the specifications (or vehicle type) of the PBV are changed according to its intended purpose and specific use cases.

In an embodiment, the main side body 20 may include a front pillar member 12, a center pillar member 13, and a rear quarter assembly 15 arranged along a front-rear direction of the vehicle body.

Herein, the rear quarter assembly 15 may be positioned at a rear portion of the main side body 20. The rear quarter assembly 15 may include a quarter pillar member 16 and a rear quarter member 17 connected to the quarter pillar member 16.

The front pillar member 12, the center pillar member 13, and the rear quarter assembly 15 of the main side body 20 may be commonly applied to the variable side structure 10b of the variable vehicle body 1b.

The common module 30 may be commonly applied to both the basic side structure 10a of the basic vehicle body 1a and the variable side structure 10b of the variable vehicle body 1b.

The common module 30 may be defined as a common component that remains unchanged even when the specifications of the PBV are modified according to its intended purpose and specific use cases.

The common module 30 may form the basic side structure body 10a of the basic vehicle body 1a together with the main side body 20.

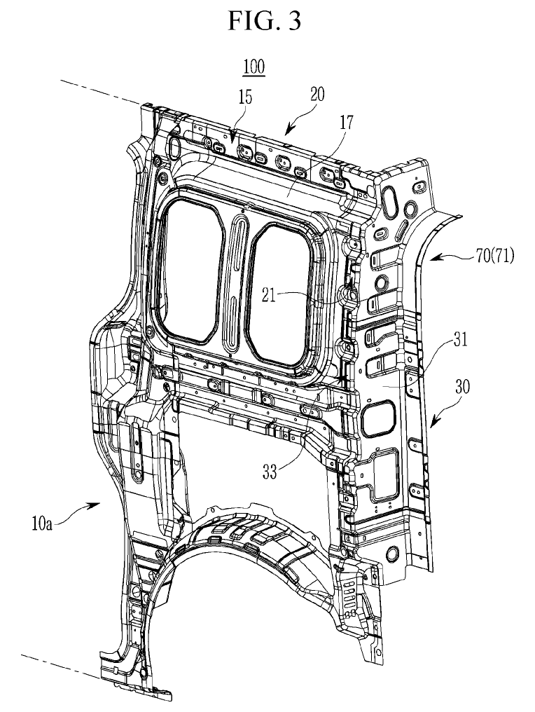

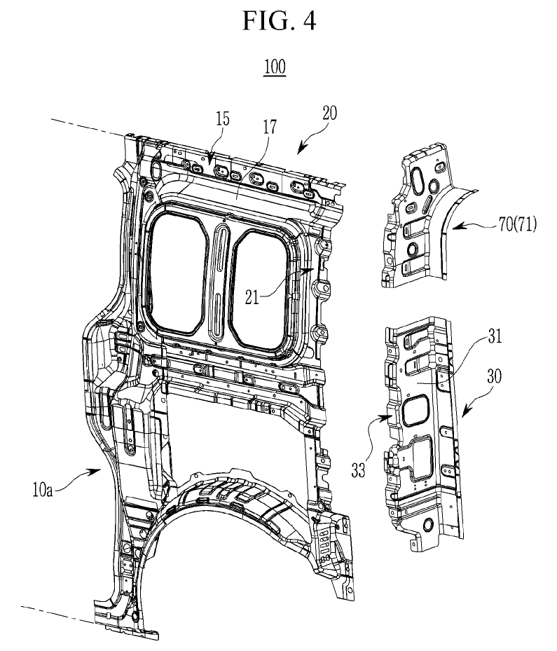

FIG. 3 illustrates a perspective view showing an example of a body side structure according to an embodiment, and FIG. 4 illustrates an exploded perspective view showing an example of a body side structure according to an embodiment.

Referring to FIGS. 3 and 4, the common module 30, according to the embodiment, may be joined to the rear quarter assembly 15 of the main side body 20 in the basic side structure 10a.

The common module 30 may be joined to a rear portion of the rear quarter assembly 15. That is, the common module 30 may be joined to a rear portion of the rear quarter member 17.

Such a common module 30 may, in an embodiment, include a rear pillar member 31.

Herein, the front pillar, the center pillar, the quarter pillar, and the rear pillar, as described above, are defined for convenience of understanding, and may be A pillar, B pillar, C pillar, and D pillar used in the industry.

The rear pillar member 31 may be joined to a rear portion of the rear quarter member 17. Furthermore, the rear pillar member 31 may be joined to the rear portion of the rear quarter member 17 in a matching join manner (also referred to as a “mating join manner”) along a width direction.

In an embodiment, a matching join manner or mating join manner may be defined as a joining approach in which shapes of two paired components (e.g., concave and convex profiles) are interlocked in a complementary manner and joined to each other. For example, among a pair of mating components, a first component may be formed with a female-shaped recess, while a second component may be formed with a male-shaped protrusion. In this case, engagement of the two mating components, wherein the male-shaped protrusion is inserted into the female-shaped recess, may be referred to as the matching join method or the mating join method.

For this purpose, the rear quarter member 17 of the rear quarter assembly 15 may be provided with a main joining portion 21. In addition, the rear pillar member 31 of the common module 30 may include a common joining portion 33.

In an embodiment, the main joining portion 21 may be formed along a vertical direction at a rear portion of the rear quarter member 17.

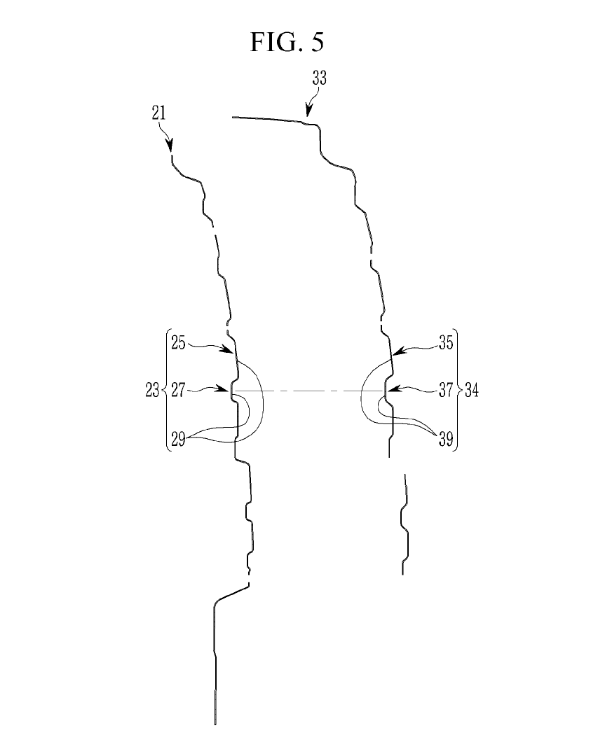

The rear quarter member 17, as shown in FIG. 5, may include first matching sections 23 arranged along a vertical direction at the rear portion of the rear quarter member 17.

The first matching sections 23 may include first matching protrusions 25 and first matching grooves 27 formed in an alternating concave-convex pattern along a vertical direction at the rear portion of the rear quarter member 17.

The first matching protrusions 25 and the first matching grooves 27 may be formed in shapes that extend inwardly and outwardly along a vehicle width direction. The first matching protrusions 25 and the first matching grooves 27 may include first matching surfaces 29 formed on concave-convex regions.

In addition, the common joining portion 33 may be formed along a vertical direction at a front portion of the rear pillar member 31 of the common module 30.

As illustrated in FIG. 5, the common joining portion 33 may include second matching sections 34 arranged along a vertical direction at a front portion of the rear pillar member 31.

The second matching sections 34 may include second matching protrusions 35 and second matching grooves 37 formed in an alternating concave-convex pattern along the vertical direction at the front portion of the rear pillar member 31.

The second matching protrusions 35 and the second matching grooves 37 may be formed in shapes that extend inwardly and outwardly along a vehicle width direction. The second matching protrusions 35 and the second matching grooves 37 may include second matching surfaces 39 formed on concave-convex regions.

Herein, as described above, the first matching sections 23 of the main joining portion 21 and the second matching sections 34 of the common joining portion 33 may be provided with the same shape.

Accordingly, the first matching sections 23 and the second matching sections 34 may be matched with each other along a vehicle width direction through the first matching surfaces 29 and the second matching surfaces 39. In addition, the first matching sections 23 and the second matching sections 34, once aligned, may be joined along the vehicle width direction, for example, by welding.

Referring to FIG. 2, in an embodiment, the variable module 50 may be configured to form the variable side structure 10b of the variable vehicle body 1b, together with the main side body 20 and the common module 30 of the basic side structure 10a.

In an embodiment, the variable module 50 may be defined as a replaceable component capable of being adapted according to the intended purpose and various vehicle types of the PBV. Herein, the term “various vehicle types” refers to diverse configurations of the variable module 50, which may include, for example, a hailing vehicle, a delivery vehicle, or a special-purpose vehicle.

Furthermore, components of the variable module (50), as well as its length in a vertical direction and width in a longitudinal direction of the vehicle body, may be variously modified according to specifications of the variable side structure 10b.

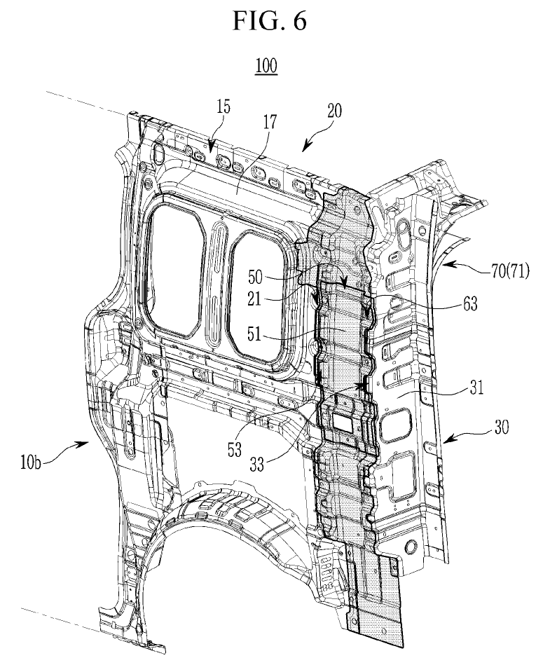

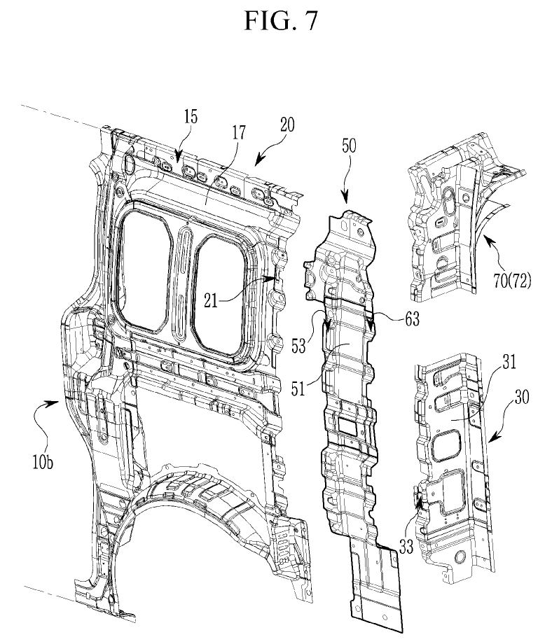

FIG. 6 illustrates a perspective view showing another example of a body side structure according to an embodiment, and FIG. 7 illustrates an exploded perspective view showing another example of a body side structure according to an embodiment.

Referring to FIGS. 6 and 7, the variable module 50 may be joined to the rear quarter assembly 15 of the main side body 20, and may be joined with the common module 30.

The variable module 50 may be joined to the rear quarter member 17 of the rear quarter assembly 15 and may also be joined to the rear pillar member 31 of the common module 30.

Herein, a front portion of the variable module 50 may be joined to the main joining portion 21 of the rear quarter member 17. In addition, a rear portion of the variable module 50 may be joined to the common joining portion 33 of the rear pillar member 31.

Such a variable module 50 may, in an embodiment, include a rear quarter extension member 51.

A front portion of the rear quarter extension member 51 may be joined to the main joining portion 21 in a matching engagement manner along the vehicle width direction. In addition, a rear portion of the rear quarter extension member 51 may joined to the common joining portion 33 in the matching engagement manner along the vehicle width direction.

To this end, the rear quarter extension member 51 may include a front variable joining portion 53 and a rear variable joining portion 63.

In an embodiment, the front variable joining portion 53 may be formed along a vertical direction at a front portion of the rear quarter extension member 51 so as to be joined to the main joining portion 21.

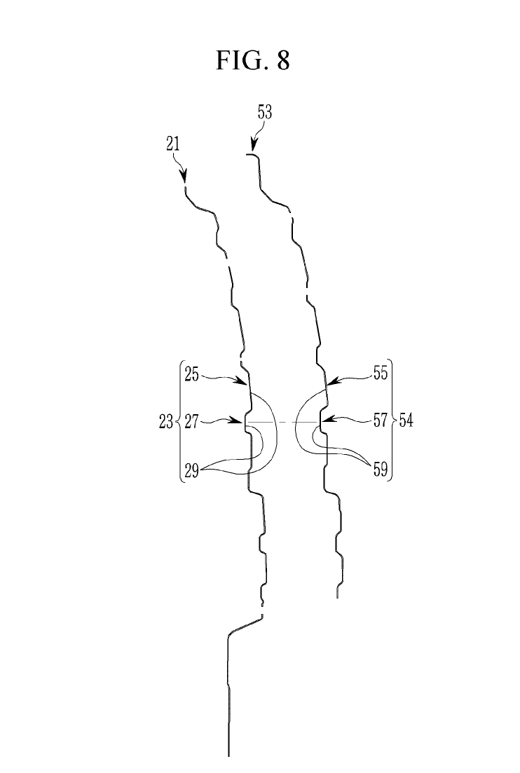

As illustrated in FIG. 8, the front variable joining portion 53 may include third matching sections 54 arranged vertically along the front portion of the rear quarter extension member 51.

The third matching sections 54 may include third matching protrusions 55 and third matching grooves 57 alternately formed in a concave-convex pattern along a vertical direction at the front portion of the rear quarter extension member 51.

The third matching protrusions 55 and the third matching grooves 57 may be formed in shapes that extend inwardly and outwardly along a vehicle width direction. The third matching protrusions 55 and the third matching grooves 57 may include third matching surfaces 59 formed on concave-convex regions.

Herein, as described above, the first matching sections 23 of the main joining portion 21 and the third matching sections 54 of the front variable joining portion 53 may be provided with the same shape.

Accordingly, the first matching sections 23 and the third matching sections 54 may be matched with each other along a vehicle width direction through the first matching surfaces 29 and the third matching surfaces 59. In addition, the first matching sections 23 and the third matching sections 54, once aligned, may be joined along the vehicle width direction, for example, by welding.

In an embodiment, a variable joining portion 63 may be formed along a vertical direction at a rear portion of the rear quarter extension member 51 so as to be joined to the common joining portion 33 of the rear pillar member 31.

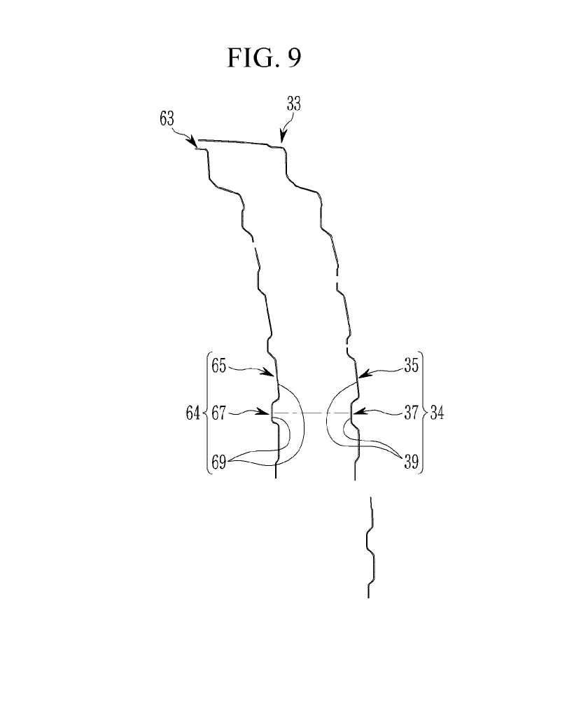

As illustrated in FIG. 9, the rear variable joining portion 63 may include fourth matching sections 64 arranged vertically along the rear portion of the rear quarter extension member 51.

The fourth matching sections 64 may include fourth matching protrusions 65 and fourth matching grooves 67 alternately formed in a concave-convex pattern along a vertical direction at the rear portion of the rear quarter extension member 51.

The fourth matching protrusions 65 and the fourth matching grooves 67 may be formed in shapes that extend inwardly and outwardly along a vehicle width direction. The fourth matching protrusions 65 and the fourth matching grooves 67 may include fourth matching surfaces 69 formed on concave-convex regions.

Herein, as described above, the second matching sections 34 of the common joining portion 33 and the fourth matching sections 64 of the rear variable joining portion 63 may be provided with a same shape.

Accordingly, the second matching sections 34 and the fourth matching sections 64 may be matched with each other along a vehicle width direction through the second matching surfaces 39 and the fourth matching surfaces 69. In addition, the second matching sections 34 and the fourth matching sections 64, once aligned, may be joined along the vehicle width direction, for example, by welding.

Meanwhile, referring to FIGS. 3, 4, 6, and 7, in an embodiment, the optional module 70 may be selectively joined to an upper portion of the common module 30, which is commonly applied to both the basic side structure 10a of the basic vehicle body 1a (see FIGS. 1 and 2) and the variable side structure 10b of the variable vehicle body 1b (see FIGS. 1 and 2).

Hereinafter, the optional module 70 connected to an upper portion of the common module 30 applied to the basic side structure 10a is referred to as a first optional module 71. The optional module 70 that is connected to the upper portion of the common module 30 applied to the variable side structure 10b is referred to as a second optional module 72.

Herein, each of the first optional module 71 and the second optional module 72 may be provided with different specifications according to a roof structure of the base vehicle body 1a and the variable vehicle body 1b, respectively.

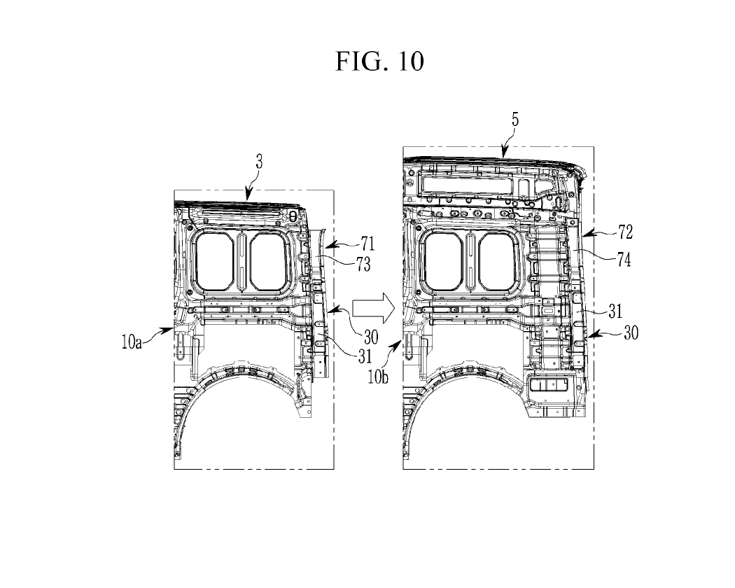

FIG. 10 illustrates a side view illustrating one example and another example of a body side structure according to an embodiment.

Referring to FIG. 10, in an embodiment, the first optional module 71 may include a first rear pillar extension member 73 connected to an upper portion of the rear pillar member 31 of the common module 30 in the basic side structure 10a.

The first rear pillar extension member 73 may be welded to the upper portion of the rear pillar member 31. The first rear pillar extension member 73 may be connected to a basic roof structure 3 provided on the basic vehicle body 1a.

Herein, the base roof structure 3 may provide a standard roof configuration, for example, a flat roof structure, in which a high roof design is not applied.

In an embodiment, the second optional module 72 may include a second rear pillar extension member 74 that is connected to an upper portion of the rear pillar member 31 of the common module 30 in the variable side structure 10b.

The second rear pillar extension member 74 may be welded to the upper portion of the rear pillar member 31. The second rear pillar extension member 74 may be connected to a variable roof structure 5 provided on the variable vehicle body 1b.

Herein, the variable roof structure 5 may provide a high roof module, which provides a high roof configuration that differs in specification from the base roof structure 3, for example.

Hereinafter, an assembly process and operation of the body side structure 100 according to an embodiment, configured as described above, will be described in detail with reference to FIGS. 1 through 10.

First, in an embodiment, a main side body 20 may be provided, which includes a front pillar member 12, a center pillar member 13, and a rear quarter assembly 15.

In the embodiment, a common module 30 including a rear pillar member 31, a variable module 50 including a rear quarter extension member 51, a first optional module 71 including a first rear pillar extension member 73, and a second optional module 72 including a second rear pillar extension member 74 may be provided.

Herein, the rear quarter assembly 15 of the main side body 20 may include a rear quarter member 17, and the rear quarter member 17 may include a main joining portion 21.

In addition, the rear pillar member 31 of the common module 30 may include a common joining portion 33, and the rear quarter extension member 51 of the variable module 50 may include a front variable joining portion 53 and a rear variable joining portion 63.

In this state, an assembly process for the basic side structure 10a of the base vehicle body 1a may be performed.

In the process, the common module 30 may be joined to the rear quarter assembly 15 of the main side body 20.

The rear quarter member 17 of the rear quarter assembly 15 and the rear pillar member 31 of the common module 30 may be joined in a matching engagement manner along the vehicle width direction via the main joining portion 21 and the common joining portion 33, which are formed in a same shape.

Herein, the main joining portion 21 may include first matching sections 23, and each of the first matching sections 23 may include first matching protrusions 25 and first matching grooves 27. In addition, the common joining portion 33 may include second matching sections 34, and each of the second matching sections 34 may include second matching protrusions 35 and second matching grooves 37.

The first matching protrusions 25 and the first matching grooves 27 may be engaged with the second matching protrusions 35 and the second matching grooves 37 along the vehicle width direction via the first matching surfaces 29 and the second matching surfaces 39.

As described above, the first matching sections 23 of the main joining portion 21 and the second matching sections 34 of the common joining portion 33, which are matched to each other, may be joined along the vehicle width direction by welding.

Next, the first rear pillar extension member 73 of the first optional module 71 may be joined to an upper portion of the rear pillar member 31 of the common module 30.

Accordingly, the assembly of the basic side structure 10a may be completed by joining the common module 30 to the rear quarter assembly 15 of the main side body 20 and further joining the first optional module 71 to an upper portion of the common module 30.

Meanwhile, in an embodiment, a process of assembling the variable side structure 10b of the variable vehicle body 1b may be performed.

In the process, the variable module 50 may be joined to the rear quarter assembly 15 of the main side body 20.

The rear quarter member 17 of the rear quarter assembly 15 and the rear quarter extension member 51 of the variable module 50 may be joined in a matching engagement manner along the vehicle width direction via the main joining portion 21 and the front variable joining portion 53, which are formed in a same shape.

Herein, the main joining portion 21 may include first matching sections 23, and each of the first matching sections 23 may include first matching protrusions 25 and first matching grooves 27. In addition, the front variable joining portion 53 may include third matching sections 54, and each of the third matching sections 54 may include third matching protrusions 55 and third matching grooves 57.

The first matching protrusions 25 and the first matching grooves 27 may be engaged with the third matching protrusions 55 and the third matching grooves 57 along the vehicle width direction via the first matching surfaces 29 and the third matching surfaces 59.

As described above, the first matching sections 23 of the main joining portion 21 and the third matching sections 54 of the front variable joining portion 53, which are matched to each other, may be joined along the vehicle width direction by welding.

Thereafter, the rear pillar member 31 of the common module 30 may be joined to the rear quarter extension member 51 of the variable module 50.

The rear quarter extension member 51 and the rear pillar member 31 may be joined to each other in a matching engagement manner along the vehicle width direction via the rear variable joining portion 63 and the common joining portion 33, which are formed in a same shape.

Herein, the common joining portion 33 may include second matching sections 34, and each of the second matching sections 34 may include second matching protrusions 35 and second matching grooves 37. In addition, the rear variable joining portion 63 may include fourth matching sections 64, and each of the fourth matching sections 64 may include fourth matching protrusions 65 and fourth matching grooves 67.

The second matching protrusions 35 and the second matching grooves 37 may be engaged with the fourth matching protrusions 65 and the fourth matching grooves 67 along the vehicle width direction via the second matching surfaces 39 and the fourth matching surfaces 69.

As described above, the second matching sections 34 of the common joining portion 33 and the fourth matching sections 64 of the rear variable joining portion 63, which are matched to each other, may be joined along the vehicle width direction by welding.

Next, the second rear pillar extension member 74 of the second optional module 72 may be joined to an upper portion of the rear pillar member 31 of the common module 30.

Accordingly, the assembly of the variable side structure 10b may be completed by joining the variable module 50 to the rear quarter assembly 15 of the main side body 20, joining the common module 30 to the variable module 50, and further joining the second optional module 72 to an upper portion of the common module 30.

According to the body side structure 100 assembled through the series of assembly processes described above, the basic side structure 10a of the basic vehicle body 1a, in which the common module 30 is joined to the main side body 20, may be provided.

In addition, according to the body side structure 100 of an embodiment, the variable side structure 10b of the variable vehicle body 1b, in which the variable module 50 and the common module 30 are joined to the main side body 20 of the base vehicle body 1a, may be provided.

Accordingly, the body side structure 100, according to an embodiment, may allow the main side body 20 of the base vehicle body 1a to be maximally shared, while enabling easy conversion to the variable side structure 10b of the variable vehicle body 1b having a larger rear overhang than that of the base vehicle body 1a.

Accordingly, the body side structure 100, according to an embodiment, may enable securing long-body performance of the variable vehicle body 1b with an increased rear overhang, while reducing a development period, design workload, tooling investment cost, and manufacturing cost required for producing multiple vehicle body specifications.

Furthermore, according to the body side structure 100 of an embodiment, compatibility and expandability of body components may be ensured based on the intended purpose and various use cases of the PBV, thereby enhancing the utilization of the PBV, enabling responsiveness to a multi-specification PBV market, and allowing for mixed or modular production based on body specifications.

While the disclosed embodiments have been described in connection with what is presently considered to be practical embodiments, it is to be understood that the disclosed embodiments are not limited thereto, but, on the contrary, is intended to cover various modifications and equivalent arrangements included within the spirit and scope of the appended claims.

What is claimed is:

1. A side structure for a vehicle body, comprising:
a main side body comprising a rear quarter assembly at a rear portion of the main side body;
a variable part optionally connectable to a rear portion of the rear quarter assembly; and
a common part connectable to the rear portion of the rear quarter assembly according to a first configuration and a rear portion of the variable part according to a second configuration.

2. The side structure of claim 1, wherein the variable part comprises a rear quarter extension member and wherein the common part comprises a rear pillar member.

3. The side structure of claim 1, wherein the common part interlockably connects to the rear portion of the rear quarter assembly along a vehicle width direction.

4. The side structure of claim 1, wherein the variable part interlockably connects to the rear portion of the rear quarter assembly along a vehicle width direction and wherein the common part interlockably connects to the rear portion of the variable part along the vehicle width direction.

5. The side structure of claim 1, wherein the rear quarter assembly comprises a main joining portion arranged in a vertical direction at the rear portion of the main side body and wherein the common part comprises a rear pillar member that comprises a common joining portion arranged in the vertical direction in a front portion of the common part.

6. The side structure of claim 5, wherein the main joining portion and the common joining portion are connectable to each other along a vehicle width direction by matching sections having a same shape located on matching surfaces.

7. The side structure of claim 5, wherein the variable part comprises a rear quarter extension member that comprises a front variable joining portion arranged along the vertical direction in a front portion of the rear quarter extension member and a rear variable joining portion arranged along the vertical direction at a rear portion of the rear quarter extension member, wherein the front variable joining portion is connectable to the main joining portion and wherein the rear variable joining portion is connectable the common joining portion.

8. The side structure of claim 7, wherein the main joining portion and the front variable joining portion are connectable to each other along a vehicle width direction by matching sections having the same shape located on matching surfaces.

9. The side structure of claim 7, wherein the common joining portion and the rear variable joining portion are connectable to each other along a vehicle width direction by matching sections having the same shape located on matching surfaces.

10. The side structure of claim 7, wherein each of the main joining portion, the common joining portion, the front variable joining portion, and the rear variable joining portion comprises a matching section having protrusions and grooves alternately arranged along a vertical direction.

11. The side structure of claim 1, further comprising an optional part connectable to an upper portion of the common part.

12. The side structure of claim 11, wherein the optional part comprises a rear pillar extension member connectable to a roof structure.

13. A side structure for a vehicle body, comprising:
a main side body comprising a rear quarter assembly at a rear portion of the main side body, the main side body being provided for a first type of purpose-built vehicle (PBV) and a second type of PBV having a different size from the first type of PBV;
a variable part provided for the first type of PBV, wherein the variable part is couplable to the rear portion of the rear quarter assembly of the main side body for the first type of PBV; and
a common part provided for the first type of PBV or the second type of PBV,
wherein the common part is couplable to a rear portion of the variable part for the first type of PBV, or
wherein the common part is couplable to the rear portion of the rear quarter assembly of the main side body for the second type of PBV, and wherein the main side body and the common part provide a basic side structure of a basic vehicle body for the second type of PBV.

14. The side structure of claim 13, wherein the main side body, the variable part, and the common part provide a variable side structure of a variable body for the first type of PBV.

15. The side structure of claim 13, wherein the common part interlocks with the rear portion of the rear quarter assembly along a vehicle width direction for the second type of PBV.

16. The side structure of claim 13, wherein the rear quarter assembly comprises a main joining portion arranged in a vertical direction at the rear portion of the main side body and wherein the common part comprises a rear pillar member that comprises a common joining portion arranged in the vertical direction in a front portion of the common part.

17. The side structure of claim 16, wherein each of the main joining portion and the common joining portion comprises a matching section having protrusions and grooves alternately arranged along the vertical direction.

18. A method of assembling a side structure of a vehicle body for a purpose-built vehicle, the method comprising:
providing a first main side body for a first type of purpose-built vehicle (PBV), wherein the first main side body comprises a first rear quarter assembly at a rear portion of the first main side body;
connecting a variable part to the rear portion of the first rear quarter assembly of the first main side body for the first type of PBV;
connecting a first common part to a rear portion of the variable part for the first type of PBV;
providing a second main side body for a second type of PBV having a different vehicle body size from the first type of PBV, wherein the second main side body comprises a second rear quarter assembly at a rear portion of the second main side body and wherein the first main side body and the second main side body have the same structure; and
connecting a second common part to the rear portion of the second rear quarter assembly of the second main side body for the second type of PBV, wherein the first common part and the second common part have the same structure.

19. The method of claim 18, wherein connecting the first common part to a rear portion of the variable part for the first type of PBV comprises interlocking the first common part with the rear portion of the variable part along a vehicle width direction.

20. The method of claim 18, wherein connecting the second common part to the rear portion of the second rear quarter assembly for the second type of PBV comprises interlocking the second common part to the rear portion of the second rear quarter assembly of the second main side body along a vehicle width direction for the second type of PBV.
